(19) United States
(12) Patent Application Publication
(10) Pub. No.: US 2008/0034394 A1
(43) Pub. Date: Feb. 7, 2008

(54) SYSTEM AND METHOD FOR CONTENT DISTRIBUTION

(76) Inventors: JOHN S. JACOBS, Weston, MA (US); Eric S. Johansson, Westford, MA (US); Robert W. Lee, Lexington, MA (US)

Correspondence Address: HOLLAND & KNIGHT LLP, 10 ST. JAMES AVENUE, 11th Floor, BOSTON, MA, 02116-3889, US

(21) Appl. No.: 11/760,422

(22) Filed: Jun. 8, 2007

Related U.S. Application Data
(63) Continuation-in-part of application No. 11/397,785, filed on Apr. 4, 2006, now abandoned.
(63) Continuation-in-part of application No. 11/397,184, filed on Apr. 4, 2006.
(63) Continuation-in-part of application No. 11/430,500, filed on May 9, 2006.
(63) Continuation-in-part of application No. 11/542,765, filed on Oct. 4, 2006.
(60) Provisional application No. 60/668,122, filed on Apr. 4, 2005.
(60) Provisional application No. 60/667,598, filed on Apr. 4, 2005.
(60) Provisional application No. 60/678,932, filed on May 9, 2005.
(60) Provisional application No. 60/723,147, filed on Oct. 4, 2005.

(51) Int. Cl. H04N 7/173

(52) U.S. Cl. 725/98

(57) ABSTRACT

A method, apparatus, and computer program product for distributing data includes transmitting a request for a data file from a first client electronic device. At least a first portion of the data file is transmitted from a second client electronic device to the first client electronic device. At least a second portion of the data file is transmitted from a third client electronic device to the first client electronic device.

### CROSS-REFERENCE TO RELATED APPLICATIONS

This application is a continuation-in-part of the following applications, which are herein incorporated by reference:

U.S. patent application Ser. No. 11/397,785, filed 04 Apr. 2006, and entitled “Recorder/Player Device Utilizing Mesh Network Content Distribution”, which claims priority to U.S. Provisional Application No. 60/668,122, filed 04 Apr. 2005, and entitled “Recorder/Player Device Utilizing Mesh Network Content Distribution”;

U.S. patent application Ser. No. 11/397,184, filed 04 Apr. 2006, and entitled “Method and System for High Reliability Mesh Distribution of Digital Content”, which claims priority to U.S. Provisional Application No. 60/667,598, filed 04 Apr. 2005, and entitled “Method and System for High Reliability Mesh Distribution of Digital Content”;

U.S. patent application Ser. No. 11/430,500, filed 09 May 2006, and entitled “Method and System for High Speed Distribution of Digital Content”, which claims priority to U.S. Provisional Application No. 60/678,932, filed 09 May 2005, and entitled “Method and System for High Speed Distribution of Digital Content”; and

U.S. patent application Ser. No. 11/542,765, filed 04 Oct. 2006, and entitled “Method and System for Distribution of Digital Content”, which claims priority to U.S. Provisional Application No. 60/723,147, filed 04 Oct. 2005, and entitled “Method and System for Distribution of Digital Content”.

### TECHNICAL FIELD

This disclosure generally relates to data file distribution, and more particularly relates to a system and apparatus for distributing data files from multiple devices.

### BACKGROUND

Content, such as television programming, movies, video games, electronic books, and the like, is distributed in a variety of ways. Outside of the use of physical media, such as DVD's, CD ROM's, video cassettes, and the like, one of the principle methods of content distribution is broadcasting. Television programs, movies, sporting events, and so on, have long been broadcast from a central distribution point, such as television broadcast stations, television cable providers, and satellite television providers. Such broadcasts may provide a wide variety of content, e.g., in the form of multiple channels, but the availability of the content is constrained by the broadcast schedule.

More recently, services have become available for making content, such as movies and television programming, available upon request by a subscriber. The content is often provided in digital format over a network such as the Internet, or through a dedicated network, such as a content provider's cable television network. These so-called video-on-demand services often have a relatively smaller selection of available content, as compared to broadcast systems, such as cable television. Additionally, while television cable systems, DSL networks, and the like, may provide high speed data transmission, the large file size associated with content such as movies may result in relatively slow transfer between a central content provider and an end consumer. The problem of transfer speeds may be exacerbated during high demand times, in which the central content provider may be simultaneously transferring content to many requesting end users.

Accordingly, it may be desirable to provide fast delivery of a variety of content that is not locked to a broadcast schedule.

### SUMMARY

In a first implementation, a method for distributing data includes transmitting a request for a data file from a first client electronic device. At least a first portion of the data file is transmitted from a second client electronic device to the first client electronic device. At least a second portion of the data file is transmitted from a third client electronic device to the first client electronic device.

One or more of the following features may be included. At least one of the first, second and third client electronic devices may be chosen from the group consisting of: a cable box, a television, a game console, a digital video recorder, a personal media player, a wireless device, a movie projector, a network router, a network hub, a network switch, a cable modem, and a DVD player. Transmitting the request for the data file may include transmitting a request to a server computer. Transmitting the request for the data file may include transmitting a request to at least one of the second and the third client electronic devices. The data file may be rendered. The first portion and the second portion of the data file may be assembled.

In another implementation, an apparatus includes a storage device for storing data. A bidirectional network interface transmits data and receives data. A processor logic is configured for: transmitting a request for a data file; receiving at least a first portion of the data file transmitted from a first client electronic device; and receiving at least a second portion of the data file transmitted from a second client electronic device.

One or more of the following features may be included. At least one of the first and second client electronic devices may be chosen from the group consisting of: a cable box, a television, a game console, a digital video recorder, a personal media player, a wireless device, a movie projector, a network router, a network hub, a network switch, a cable modem, and a DVD player. Transmitting the request for the data file may include transmitting a request to a server computer. Transmitting the request for the data file may include transmitting a request to at least one of the first client electronic device and the second client electronic device. The processor logic may be further configured for rendering the data file. The processor logic may be further configured for assembling the first portion and the second portion of the data file.

In another implementation, a computer program product residing on a computer readable medium is coupled to a first client electronic device. The computer readable medium has a plurality of instructions stored on it which, when executed by a processor, cause the processor to perform operations including transmitting a request for a data file from the first client electronic device. At least a first portion of the data file is received from a second client electronic device. At least a second portion of the data file is received from a third client electronic device.

One or more of the following features may be included. At least one of the first, second, and third client electronic devices may be chosen from the group consisting of: a cable box, a television, a game console, a digital video recorder, a personal media player, a wireless device, a movie projector, a network router, a network hub, a network switch, a cable modem, and a DVD player. The instructions for transmitting the request for the data file may further include instructions for transmitting a request to a server. The instructions for transmitting the request for the data file may further include instructions for transmitting a request to at least one of the second and the third client electronic devices. The data file may be rendered. The first portion and the second portion of the data file may be assembled.

The details of one or more implementations are set forth in the accompanying drawings and the description below. Other features and advantages will become apparent from the description, the drawings, and the claims.

### BRIEF DESCRIPTION OF THE DRAWINGS

FIG. 1 diagrammatically depicts a multi-device, data distribution process executed on a distributed computing network; and

FIG. 2 is a flowchart of the multi-device data distribution process of FIG. 1.

### DESCRIPTION

Server-Side Process

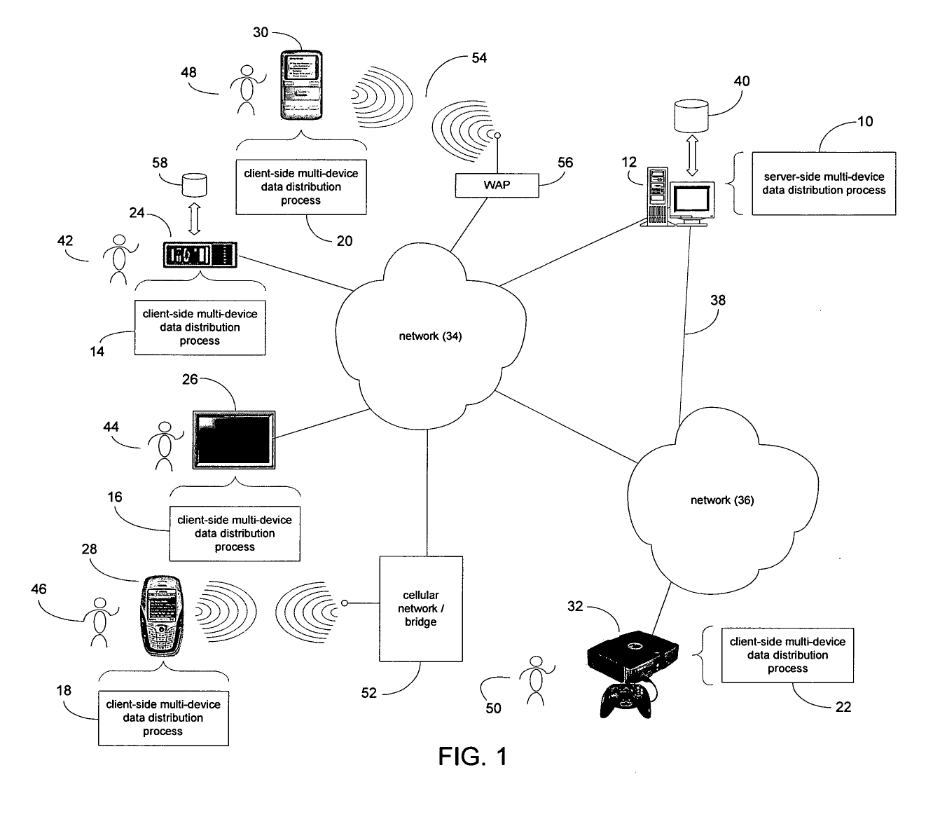

Referring to FIG. 1, there is shown a multi-device data distribution process, which may include a server-side process (e.g., server-side multi-device data distribution process 10) that may reside on (in whole or in part) and may be executed by (in whole or in part) server computer 12 (e.g., a single server computer, a plurality of server computers, or general purpose computer, for example).

Alternatively/additionally, multi-device data distribution process may include a client-side process (e.g., client-side multi-device data distribution process 14, 16, 18, 20, 22), which may reside on (in whole or in part) and may be executed by (in whole or in part) a client electronic device, which may be a purpose-specific device dedicated to storing, distributing/receiving, and consuming media content, examples of which may include but are not limited to cable box 24, television 26, data-enabled cellular telephone 28, personal media device 30, game console 32, a video projector (not shown), a digital video recorder (not shown), an in-car entertainment system (not shown), a DVD player (not shown), a network router (not shown), a network hub (not shown), a network switch (not shown), a cable modem (not shown), a movie projector (not shown), and a personal digital assistant (not shown). As will be discussed in greater detail below, multi-device data distribution process 10, 14, 16, 18, 20, 22 may allow for the distribution of data files from a plurality of client electronic devices to a requesting client electronic device.

Server computer 12 may be coupled to network 34, examples of which may include but are not limited to a distributed computing network (e.g., the Internet), a telecommunications network (e.g., a telephone network), and a media distribution network (e.g., a cable television network). Server computer 12 may be a web server running a network operating system, examples of which may include, but are not limited to, Microsoft Windows XP Server™, or Redhat Linux™.

Server computer 12 may execute a web server application, examples of which may include, but are not limited to, Microsoft IIS™, or Apache Webserver™, that allows for HTTP (i.e., HyperText Transfer Protocol) access to server computer 12 through network 34. Network 34 may be coupled to one or more secondary networks (e.g., network 36), such as a local area network, a wide area network, or an intranet, for example. Additionally/alternatively, server computer 12 may be coupled to network 34 through secondary network 36, as depicted with phantom link line 38.

The instructions and subroutines of server-side, multi-device data distribution process 10, which may be stored on storage device 40 coupled to server computer 12, may be executed by one or more processors (not shown), and by one or more memory architectures (not shown) incorporated into server computer 12. Storage device 40 may include, but is not limited to, a hard disk drive, a tape drive, an optical drive, a redundant array of independent disks (i.e., RAID array), a random-access memory (i.e., RAM), or a read-only memory (i.e., ROM), for example.

Users 42, 44, 46, 48, 50 may access server side multi-device data distribution process 10, either directly though network 34, or through secondary network 36, using various client electronic devices (e.g., devices 24, 26, 28, 30, 32) coupled to at least one of networks 34, 36, e.g., via a bidirectional network interface (not shown). As disclosed above, a client electronic device may be a purpose-specific device dedicated to storing, distributing/receiving, and consuming media content, examples of which may include but are not limited to cable box 24, television 26, cellular phone 28, personal media device 30, game console 32, a video projector (not shown), a digital video recorder (not shown), an in-car entertainment system (not shown), a DVD player (not shown), a network router (not shown), a network hub (not shown), a network switch (not shown), a cable modem (not shown), a movie projector (not shown), and a personal digital assistant (not shown), for example.

The various client electronic devices may be directly or indirectly coupled to network 34 and/or secondary network 36. For example, cable box 24 and television 26 may be directly coupled to network 34, via hard wired connections. Further, cellular phone 28 may be wirelessly coupled to a cellular network/bridge 52, which is coupled to network 34. Similarly, personal media device 30 may be wirelessly coupled to network 34 by wireless communication channel 54 established between personal media device 30 and wireless access point (WAP) 56 (which is coupled to network 34). Game console 32 may be coupled to network 34 via secondary network 36.

WAP 56 may be, for example, an IEEE 802.11a, 802.11b, 802.11g, Wi-Fi, and/or Bluetooth device that is capable of establishing secure communication channel 54 between personal media device 30 and WAP 56. The various IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (CCK) modulation, or example. Bluetooth is a telecommunications industry specification that may allow, e.g., mobile phones, computers, and personal digital assistants, to be interconnected using short-range wireless connection.

Client-Side Process

As discussed above, the client electronic devices (e.g., cable box 24, television 26, cellular phone 28, personal media player 30, game console 32, may each execute a client-side, multi-device data distribution process (e.g., client-side multi-device data distribution processes 14, 16, 18, 20, 22, respectively). Client side, multi-device data distribution processes 14, 16, 18, 20, 22 may allow one or more respective users (e.g., users 42, 44, 46, 48, 50) to request and receive data files from one or more of the client electronic device and/or server computer 12.

Client-side, multi-device, data distribution processes 14, 16, 18, 20, 22 may be stand-alone applications or may be modules, applets, or plug-ins that operate within other applications, examples of which may include but are not limited to web browser applications (e.g., Microsoft Internet Explorer™, Mozilla Firefox™, and Netscape Navigator™).

Client electronic devices (e.g., cable box 24, television 26, cellular phone 28, personal media player 30, and game console 32) may execute an operating system, examples of which may include but are not limited to Microsoft Windows XP™, Microsoft Windows Mobile™, and Redhat Linux™, for example.

The instruction sets and subroutines of client-side, multi-device data distribution processes 14, 16, 18, 20, 22, which may be stored on storage devices coupled to the respective client electronic devices, such as storage device 58 coupled to cable box 24, and corresponding storage devices (not shown) respectively coupled to the other client electronic devices (e.g., television 26, cellular phone 28, personal media player 30, and game console 32), may be executed by one or more processors (not shown) and one or more memory architectures (not shown) incorporated into the client electronic devices (e.g., cable box 24, television 26, cellular phone 28, personal media player 30, and game console 32). Examples of the storage devices (e.g., storage device 58) may include, but are not limited to, a hard disk drive, a tape drive, an optical drive, a redundant array of independent disks (i.e., a RAID array), a random-access memory (i.e., RAM), a read-only memory (i.e., ROM), a compact flash (i.e., CF) storage device, a secure digital (i.e., SD) storage device, and memory stick storage device.

Multi-Device Data Distribution Process Operation

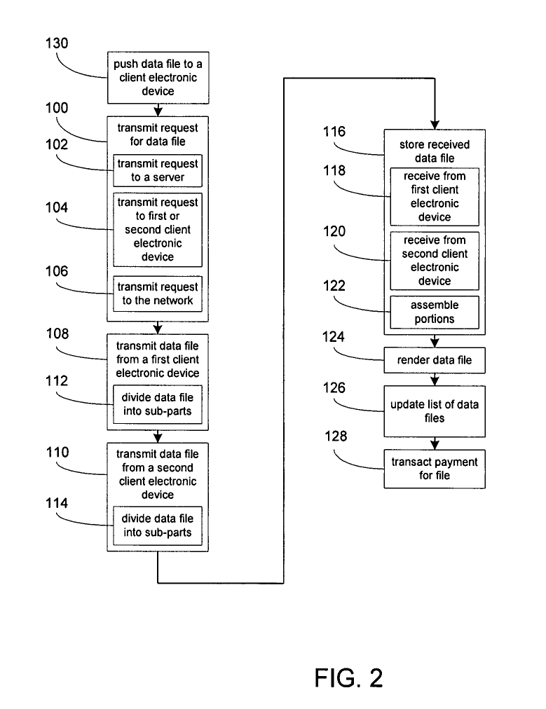

Referring also to FIG. 2, server-side, multi-device data distribution process 10, client-side, multi-device data distribution processes 14, 16, 18, 20, 22, or a combination of server-side, multi-device data distribution process 10 and client-side multi-device data distribution processes 14, 16, 18, 20, 22 may allow a user (e.g., user 42 of cable box 24) to request and receive a data file from a plurality of client electronic devices (e.g., television 26, cellular phone 28, personal media device 30, or game console 32).

Additionally, the entire data file requested need not be provided by a single client electronic device. For example, two or more of the client electronic devices (e.g., television 26, cellular phone 28, personal media device 30, and game console 32) may each have at least a portion of the requested data file stored on the respective storage device (not shown) coupled thereto. Accordingly, two or more of the client electronic devices having the requested data file stored thereon may each transmit at least a portion of the requested data file to the requesting client electronic device (e.g., cable box 16).

The data files that may be requested and received may include but are not limited to video files (e.g., television programming, feature films, sporting event broadcast), audio files, videogames, electronic books, video lectures, software applications, software patches/updates for e.g., television 26, cellular phone 28, personal media device 30, and game console 32, and the like. For example, multi-device data distribution processes 10, 14, 16, 18, 20, 22 maybe used in connection with a media distribution service (e.g., a video-on-demand service; not shown) of which user 42 may be a subscriber. In such an example, the data files may be e.g., video data files of movies and/or television programs that may be available through the video-on-demand service for downloading/viewing by subscribers, e.g., user 42.

Continuing with the above-stated example in which user 42 is a subscriber of a video-on-demand service that uses multi-device data distribution processes 10, 14, 16, 18, 20, 22 for distribution of video files to subscribers, if user 42 wishes to watch the movie “Cinderella”, user 34 may request the movie by inputting the title of the requested movie using e.g., an input device such as a keyboard (not shown), a screen pointer (not shown), or a plurality of menus (not shown) in conjunction with a remote control configured to control e.g., cable box 24. Additionally/alternatively, multi-device data distribution process 14 may be capable of transmitting scheduled requests for data files, e.g., for requesting a recurring television program, or feature film on a specified date.

Multi-device data distribution process 14 being executed on cable box 24 may transmit 100 a request for the data file of the movie “Cinderella”. Transmitting 100 the request for the data file may include transmitting 102 the request for the movie “Cinderella” to server computer 12. Server computer 12 may identify the client electronic devices coupled to networks 34, 36 that contain at least a portion of the video data file for the movie “Cinderella”.

Server computer 12 may e.g., maintain a listing of the various client electronic devices coupled to networks 34, 36 and the data files stored on each of the devices. Based on the listing of client electronic devices and associated data files stored thereon, server computer 12 may, for example, identify television 26 and game console 32 as having at least a portion of the movie “Cinderella” stored on the respective storage devices (not shown) coupled thereto. The listing of the data files maintained on the client electronic devices may be maintained e.g., in a database on storage device 40. Examples of the database may include, but are not limited to, an Oracle™ database, an IBM DB2™ database, a Sybase™ database, a Computer Associates™ database, and a Microsoft Access™ database.

Continuing with the above-stated example and in response to the request transmitted 100, server computer 12 may e.g., transmit an instruction/request to television 26 and game console 32 (each of which contains at least a portion of the requested video data file) to transmit the requested video data file of the movie “Cinderella” to cable box 24. Additionally/alternatively, server computer 12 may transmit the location/identification (e.g., the IP address) of each of the client electronic devices containing at least a portion of the requested video data file (i.e., television 26 and game console 32) to the multi-device data distribution process 14 running on cable box 24. Accordingly, multi-device data distribution process 14 may transmit a request for the video data file from cable box 24 directly to television 26 and game console 32, which were identified by server computer 12 as containing at least a portion of the requested video data file.

In a similar fashion, a listing of the data files stored on the various client electronic devices (e.g., cable box 24, television 26, cellular phone 28, personal media device 30, and game console 32) that are coupled to networks 34, 36 may be maintained on each of the client electronic devices. For example, the listing of the data files stored on the various client electronic devices coupled to networks 34, 36 may be stored in a database maintained on storage device 58 (i.e., the storage device coupled to cable box 24). Examples of the database may include, but are not limited to, an Oracle™ database, an IBM DB2™ database, a Sybase™ database, a Computer Associates™ database, and a Microsoft Access™ database. Accordingly, multi-device data distribution process 14 may transmit 104 a request for the video data file (e.g., “Cinderella”) directly to those client electronic devices identified (within the database) as containing at least a portion of the desired video data.

According to another example, multi-device data distribution process 14 may transmit 106 the request for the desired data file (i.e., “Cinderella”) to all of the client electronic devices (e.g., television 26, cellular phone 28, personal media device 30, and game console 32) that are coupled to networks 34, 36. That is, multi-device data distribution process 14 may broadcast the request for the movie “Cinderella” across networks 34, 36. The broadcast request may be received by any client electronic device coupled to networks 34, 36 (e.g., television 26, cellular phone 28, personal media device 30, and game console 32). By broadcasting the request, the necessary storage space required by each client electronic device may be reduced, and the overhead associated with maintaining and updating the list of client electronic devices may be eliminated.

The speed at which data files may be distributed to a requesting client electronic device (i.e., the speed at which data files may be transmitted from transmitting client electronic devices and received by a requesting client electronic device) may be based, at least in part, upon the upload speed of the transmitting client electronic devices and the download speed of the requesting client electronic device. Often, the available upload speed of a network connection may be much slower than the available download speed. As such, the distribution speed of a data file transmitted from a single sender may be limited by the upload speed of the sender's network connection. As such, the download capacity of the requesting client electronic device may be underutilized.

The limitation on the distribution speed associated with a single sender may, at least in part, be overcome by multi-device data distribution processes 10, 14, 16, 18, 20, 22. Multi-device data distribution processes 10, 14, 16, 18, 20, 22 may increase distribution speed by concurrently transmitting the requested data file from a plurality of sources, i.e., a plurality of client electronic devices each having at least a portion of the requested data file stored on their respective storage device. The aggregate upload speed of the plurality of transmitting client electronic devices may be greater than the upload speed of any single client electronic device. For example, four client electronic devices transmitting portions of a data file to a single receiving client electronic device at a rate of 100 kbps per upload connection may have an aggregate upload speed of 400 kbps. The foregoing upload speeds are provided for simplicity of explanation, and are not indicative of, or limiting on, actual usable upload speeds. The aggregate upload speed of the plurality of transmitting client electronic devices may better utilize the available download speed of the requesting client electronic device to achieve a faster distribution time.

Continuing with the above-stated example, television 26 and game console 32 may each have at least a portion of the movie “Cinderella” stored on the storage device (not shown) associated with the respective client electronic device. Respective multi-device data distribution processes 16, 22 running on television 26 and game console 32 may each transmit at least a portion of the data file for the movie “Cinderella” to multi-device data distribution process 14 running on cable box 24. For example, multi-device data distribution process 16 may transmit 108 at least a first portion of the movie “Cinderella”, which may be stored on the storage device (not shown) coupled to television 26, to multi-device data distribution process 14 running on cable box 24. Similarly, multi-device data distribution process 22 running on game console 32 may also transmit 110 at least a second portion of the data file of the movie “Cinderella”, which may be stored on the storage device (not shown) coupled to game console 32, to multi-device data distribution process 14 resident on cable box 24.

As noted above, concurrent transmission of portions of the data file by each of multi-device data distribution processes 16, 22 may yield an aggregate upload speed that is greater than the upload speed of either of multi-device data distribution processes 16, 22 alone. Being that it is not required that the transmissions be entirely concurrent, the distribution time for a data file may depend, at least in part, upon the number of client electronic devices transmitting at least a portion of the data file. The distribution time for a data file may be decreased by increasing the number of transmitting client electronic devices (and, therefore, the aggregate upload speed), up to the point at which the maximum download speed of the network connection/receiving client electronic device is realized.

Each multi-device data distribution process 16, 22 transmitting 108, 110 at least a portion of the requested data file may divide 112, 114 the requested data file into a plurality of sub-portions. Each of the sub-portions may be separately transmittable to the requesting multi-device data distribution process (e.g., multi-device data distribution process 14). Dividing 112, 114 the requested data file into a plurality of sub-portions, and separately transmitting the individual sub-portions may facilitate transmitting the requested data file via a plurality of multi-device data distribution processes. Multi-device data distribution processes 16, 22 may each transmit one or more sub-portions of the requested data file. The sub-portions transmitted by e.g., either multi-device data distribution process 16 or multi-device data distribution process 22 may not account for the entire requested data file. However, the combination of the sub-portions transmitted by multi-device data distribution processes 16, 22 may provide the entire requested data file.

Concurrently transmitting portions of the data file, e.g., in the form of sub-portions, from a plurality of client electronic devices may optimize the available download bandwidth of the receiving multi-device data distribution process (e.g., multi-device data distribution process 14). In the above example, only two transmitting multi-device data distribution processes 16, 22 have been discussed for illustrative purposes. However, more than two multi-device data distribution processes may concurrently and/or sequentially transmit at least a portion of the requested data file to the requesting multi-device data distribution process.

The division of the data file into sub-portions by the transmitting multi-device data distribution process, e.g., multi-device data distribution processes 16, 22 may be coordinated by server computer 12, e.g., by multi-device data distribution process 10 running on server computer 12. Server computer 12 may determine e.g., the size of the sub-portions into which the data file is broken, and which sub-portions are to be transmitted by the various multi-device data distribution processes. The size of the sub-portions may be the same, or may vary from one sub-portion to another and/or from one transmitting client electronic device to another.

Alternatively, server computer 12 may divide the data file into sub-portions prior to initial transmission of the data file, thus eliminating the need for the client electronic device to perform the file division process. If server computer 12 divides the data file into sub-portions, the divided file may be retained on the device receiving the divided file. Accordingly, while the divided file may be assembled by the receiving device to facilitate e.g., rendering of the divided file, a copy of the divided file may be maintained in a divided fashion to facilitate subsequent transmission of all or a portion of the divided file to another device.

Alternatively/additionally, the manner in which the data file is divided into sub-portions, the transmission order of the sub-portions, and the client electronic device transmission assignments may be determined by: the receiving multi-device, data distribution process (e.g., multi-device, data distribution process 14); the transmitting multi-device, data distribution process(es) (e.g., transmitting multi-device, data distribution processes 16, 22); or the combination of the receiving and transmitting multi-device, data distribution processes (e.g., multi-device, data distribution processes 14, 16, 22).

The dividing 112, 114 of the data file into sub-portions and transmitting 108, 110 the sub-portions may be accomplished according to pre-established rules, randomly, or a combination thereof. For example, the data file may be divided 112, 114 into sub-portions based upon established rules, e.g., based upon network characteristics and/or data file characteristics (e.g., total data file size and data file type). Similarly, the sub-portions may be transmitted in a prescribed order. For example, multi-device data distribution process 16 may transmit sub-portions corresponding to a first half of the data file and multi-device data distribution process 22 may transmit sub-portions corresponding to a second half of the data file. Alternatively, multi-device data distribution processes 16, 22 may transmit alternating/random sub-portions.

Dividing 112, 114 the data file into smaller sub-portions may facilitate transmission of the requested data file by a larger number of transmitting client electronic devices. For example, a greater number of sub-portions (e.g., due to a smaller sub-portion size) may allow a greater number of client electronic devices to transmit a portion of the data file without excessive redundancy. Additionally/alternatively, smaller sub-portions may allow client electronic devices containing only a small portion of the requested data file to transmit one or more sub-portions of the data file. As noted above, the size of the sub-portions may vary from one sub-portion to another and from one transmitting client electronic device to another. Therefore, a client electronic device having only a small portion of the requested data file may transmit the small portion of the requested data file, even if that portion is smaller than the sub-portions being transmitted by other transmitting client electronic devices.

Smaller sub-portions may also alleviate problems of redundant and/or overlapping portions of the data file. For example, if the data file is transmitted without coordination between the transmitting client electronic devices, redundant or overlapping sub-portions may be transmitted by each client electronic device. That is, each transmitting client electronic device may transmit the same sub-portion. Smaller sub-portions may, at least in part, alleviate the efficiency loss resulting from redundant transmissions. For example, the redundant sub-portions may be smaller in size and/or less frequently occurring.

Multi-device data distribution process 14 may store 116 the requested data file on storage device 58 coupled to cable box 24. Storing 116 the data file may include receiving 118 at least a first portion of the data file from the first transmitting client electronic device (e.g., the portion transmitted by multi-device data distribution process 16) and receiving 120 at least a second portion of the data file from the second transmitting client electronic device (e.g., the portion transmitted by multi-device data distribution process 22).

Multi-device data distribution process 14 running on cable box 16 may assemble 122 the portions of the data file received from the various transmitting client electronic devices (e.g., television 26 and game console 32) to form the complete data file.

Assembling 122 the received portions of the data file may include, but is not limited to, creating and saving a single discrete file including the received portions and/or associating the received portions. Creating a single discrete file including the received portions may include e.g., ordering the received sub-portions of the data file (e.g., based on offset information) and saving the ordered sub-portions of the data file as a single data file. Associating the received portions of the data file may include e.g., creating logical associations between the received portions based on offset information or other ordering characteristics.

Once the received data file has been stored 116, multi-device data distribution process 14 may render 124 the data file. Continuing with the above-stated example in which the received data file is a video data file of the movie “Cinderella,” multi-device data distribution process 14 may, alone or in conjunction with one or more additional processes and/or hardware components, render 124 the movie “Cinderella” either directly or in conjunction with an additional device (e.g., a television set (not shown) or display screen (not shown) coupled to cable box 24). Alternatively/additionally, multi-device data distribution process 14 may otherwise make the received data file available for processing consistent with the nature of the data file (e.g., video file, video game, electronic book).

In an embodiment in which server computer 12 maintains a listing (e.g., in a database stored on storage device 40) of data files and/or client electronic devices upon which data files are stored, one or more of multi-device data distribution processes 10, 14 may update 126 the list of data files and associated client electronic devices upon which the data files are stored. The updated list may facilitate the subsequent distribution of the received data file to other client electronic devices coupled to networks 34, 36 from cable box 24. Similarly, multi-device data distribution process 14 may update any other listings of available data files and associated client electronic devices maintained, e.g., on one or more of the client electronic devices coupled to networks 34, 36.

As mentioned above, multi-device data distribution process 14 may be used in connection with a media distribution service, such as a video on demand service. Some or all of the data files may be distributed at a fee. Continuing with the above-stated example, one or more of multi-device data distribution processes 10, 14, 16, 18, 20, 22 may charge 128 transaction fees for the requested data file (e.g., once the file has been received, when the file is requested, or during transmission of the file). Various transaction arrangements may be used e.g., based on the specific content of the data file and/or the time of the transfer, for example. Compensation may be made to the service provider. For example, in the context of a video on demand service, compensation may be made to the service provider for the content. Additionally/alternatively, compensation may be made to the participating client electronic devices (or owners thereof), from which the data file was transferred.

As discussed with reference to the above-stated example, the distribution time for a data file may be decreased as the number of client electronic devices (which include at least a portion of the data file) increases. As also described by the above-stated example, data files may come to be stored on the various client electronic devices as a result of the previous requests for the data file. For example, user 44 requested the data file for the movie “Cinderella”, which was subsequently transferred to, and saved on storage device 58 of cable box 24. Accordingly, cable box 24 may also be available for subsequently distributing the data file of the movie “Cinderella” to other requesting client electronic devices. As such, the number of client electronic devices capable of transmitting the data file of the movie “Cinderella” has been increased as a result of the request from user 44.

Popular data files (i.e., data files requested by many users) may be stored, in whole or in part, on the storage devices of numerous client electronic devices. The distribution time for a popular data file may be relatively quick due to a large number of available transmitting client electronic devices. As more client electronic devices request and receive the data file, the distribution time may become quicker (up to the maximum available download speed of a given network connection) as the number of available transmitting client electronic devices increases.

In addition to the natural propagation of popular data files resulting from multiple requests for the data file, one or more of the client electronic devices may also be prepared for the anticipated popularity of a data file. For example, once again in the context of a data file of a feature film, it may be expected that the video release of a movie will be extremely popular based on the performance of the movie during its theatrical release. Prior to its availability for download, the data file of the movie may be placed on the storage devices of one or more client electronic devices. For example, server computer 12 may push 130 the data file to the storage device of one or more of the client electronic devices. For example, server-side multi-device data distribution process 10, alone or in conjunction with client-side multi-device data distribution process 14, may download the data file to cable box 24, and store the data file on storage device 58. Once the data file is stored on storage device 58, the data file may be available for download (e.g., immediately, on a specified date, at a specified time, and/or only to specific users). Users requesting the data file may receive at least a portion of the data file from the client electronic device to which the file was pushed, e.g., cable box 24.

Pushing 130 the data file to one or more client electronic devices may at least partially alleviate initial network congestion e.g., resulting from the need for a single source transmission and/or multiple requests for a file that is available from only a relatively small number of client electronic devices. Accordingly, pushing 130 the data file to various client electronic devices may alleviate/reduce bandwidth consumption and network congestion. For example, rather than initially relying upon a single source for downloading the data file, server computer 12 may push 130 the data file to multiple client electronic devices, thus making them available for transmitting the data file to requesting client electronic device.

According to another aspect, one or more of server-side, multi-device, data distribution process 10 and client-side, multi-device data distribution processes 14, 16, 18, 20, 22 may control the access to, or distribution of, one or more data files. Access to or distribution of a data file may be controlled based upon, but not limited to, data file content, distribution time frame, and requesting client electronic device. For example, a motion picture production company may provide an extended preview of a movie for e.g., three weeks. The data file for the extended preview may be freely distributed to (and between) client electronic devices during the three week time frame. However, after the expiry of the three week time frame, the file may be restricted against further distribution and/or display.

According to another feature of this disclosure, one or more of multi-device, data distribution processes 10, 14, 16, 18, 20, 22 may enable real time, or near-real time rendering of a data file as it is being transmitted 108, 110. For example, again in the context of the movie file for “Cinderella” requested by multi-device data distribution process 14 running on cable box 24, multi-device data distribution processes 16, 22 may each transmit 108, 110 at least a portion of the data file for the move “Cinderella” to cable box 24. To enable real time, or near real time, viewing of “Cinderella”, one or more of multi-device data distribution processes 16, 22 may, in response to a specific request by multi-device, data distribution process 14, transmit sub-portions of the requested data file corresponding to the beginning of the movie “Cinderella”. As such, once the sub-portions have been received and stored, e.g., on storage device 58, the received portions of the data file may be rendered.

Real time (or near real time) rendering of the data file may be facilitated by coordinating the transmission of sub-portions of the data file by multi-device, data distribution processes 16, 22. For example, transmission of sub-portions of the data file may be coordinated to: reduce/eliminate redundant sub-portions; to minimize/eliminate overlap of sub-portions; and/or to provide alternating sub-portions from the transmitting multi-device, data distribution processes 16, 22. The transmission by multi-device, data distribution processes 16, 22 may be coordinated by e.g., multi-device, data distribution process 10, multi-device, data distribution process 14, or between transmitting multi-device, data distribution processes 16, 22. Additionally, the size of the sub-portions may be relatively small to decrease transmission time of each individual sub-portion, thus reducing the time before the sub-portion may be rendered by cable-box 24.

A number of implementations have been described. Nevertheless, it will be understood that various modifications and alterations may be made. Accordingly, other implementations are within the scope of the following claims.

What is claimed is:

1. A method for distributing data comprising:
transmitting a request for a data file from a first client electronic device;
transmitting at least a first portion of the data file from a second client electronic device to the first client electronic device; and
transmitting at least a second portion of the data file from a third client electronic device to the first client electronic device.

2. The method of claim 1 wherein at least one of the first, second and third client electronic devices is chosen from the group consisting of: a cable box, a television, a game console, a digital video recorder, a personal media player, a wireless device, a movie projector, a network router, a network hub, a network switch, a cable modem, and a DVD player.

3. The method of claim 1 wherein transmitting the request for the data file includes:
transmitting a request to a server computer.

4. The method of claim 1 wherein transmitting the request for the data file includes:
transmitting a request to at least one of the second and the third client electronic devices.

5. The method of claim 1 further comprising:
rendering the data file.

6. The method of claim 1 further comprising:
assembling the first portion and the second portion of the data file.

7. An apparatus comprising:
a storage device for storing data;
a bidirectional network interface for transmitting data and receiving data; and
a processor logic configured for:
transmitting a request for a data file;
receiving at least a first portion of the data file transmitted from a first client electronic device; and
receiving at least a second portion of the data file transmitted from a second client electronic device.

8. The apparatus of claim 7 wherein at least one of the first and second client electronic devices is chosen from the group consisting of: a cable box, a television, a game console, a digital video recorder, a personal media player, a wireless device, a movie projector, a network router, a network hub, a network switch, a cable modem, and a DVD player.

9. The apparatus of claim 7 wherein transmitting the request for the data file includes:
transmitting a request to a server computer.

10. The apparatus of claim 7 wherein transmitting the request for the data file includes:
transmitting a request to at least one of the first client electronic device and the second client electronic device.

11. The apparatus of claim 7 wherein the processor logic is further configured for:
rendering the data file.

12. The apparatus of claim 7 wherein the processor logic is further configured for:
assembling the first portion and the second portion of the data file.

13. A computer program product residing on a computer readable medium coupled to a first client electronic device, the computer readable medium having a plurality of instructions stored thereon which, when executed by a processor, cause the processor to perform operations comprising:
transmitting a request for a data file from the first client electronic device;
receiving at least a first portion of the data file from a second client electronic device; and
receiving at least a second portion of the data file from a third client electronic device.

14. The computer program product of claim 13 wherein at least one of the first, second, and third client electronic devices is chosen from the group consisting of: a cable box, a television, a game console, a digital video recorder, a personal media player, a wireless device, a movie projector, a network router, a network hub, a network switch, a cable modem, and a DVD player.

15. The computer program product of claim 13 wherein the instructions for transmitting the request for the data file further include instructions for:
transmitting a request to a server.

16. The computer program product of claim 13 wherein the instructions for transmitting the request for the data file further include instructions for:
transmitting a request to at least one of the second and the third client electronic devices.

17. The computer program product of claim 13 further comprising instructions for:
rendering the data file.

18. The computer program product of claim 13 further comprising instructions for:
assembling the first portion and the second portion of the data file.
